(19) United States
(12) Patent Application Publication
(10) Pub. No.: US 2014/0043453 A1
(43) Pub. Date: Feb. 13, 2014

(54) ENDOSCOPE FOR STORING IMAGES

(71) Applicant: Hoya Corporation, Tokyo (JP)

(72) Inventors: Masaaki FUKUDA, Tokyo (JP); Junko ISAWA, Tokyo (JP); Akihiro ITO, Saitama (JP)

(73) Assignee: HOYA CORPORATION, Tokyo (JP)

(21) Appl. No.: 13/951,865

(22) Filed: Jul. 26, 2013

(30) Foreign Application Priority Data
Aug. 10, 2012 (JP) 2012-178775

(51) Int. Cl. H04N 7/18

(52) U.S. Cl. CPC H04N 7/18
USPC 348/65

(57) ABSTRACT

An endoscope is provided having a video compiler, a still-image compiler, a monitor, and a recorder. The video compiler continuously receives image signals and creates a video file with the image signals. The still-image compiler receives the image signals, and creates a still image. The monitor receives the video file from the video compiler and continuously displays the video. The recorder receives the video file from the video compiler and receives the still image from the still-image compiler, and stores the video file and the still image.

### BACKGROUND OF THE INVENTION

### Field of the Invention

The present invention relates to an imager for storing an image.

### SUMMARY OF THE INVENTION

An object of the present invention is to provide an endoscope that stores not only a still image but also a video at the same time.

According to the present invention, an endoscope is provided that comprising a video compiler, a still-image compiler, a monitor, and a recorder. The video compiler continuously receives image signals and creates a video file with the image signals. The still-image compiler receives the image signals, and creates a still image. The monitor receives the video file from the video compiler and continuously displays the video. The recorder receives the video file from the video compiler and receives the still image from the still-image compiler, and stores the video file and the still image.

### BRIEF DESCRIPTION OF THE DRAWINGS

The objects and advantages of the present invention will be better understood from the following description, with reference to the accompanying drawings in which:

FIG. 1 is a block diagram showing the endoscope as an embodiment of the present invention;

FIG. 2 is a block diagram showing a video-recording controller;

FIG. 3 is a block diagram showing a video-retrieving controller; and

FIG. 4 is a flowchart showing a video-recording process.

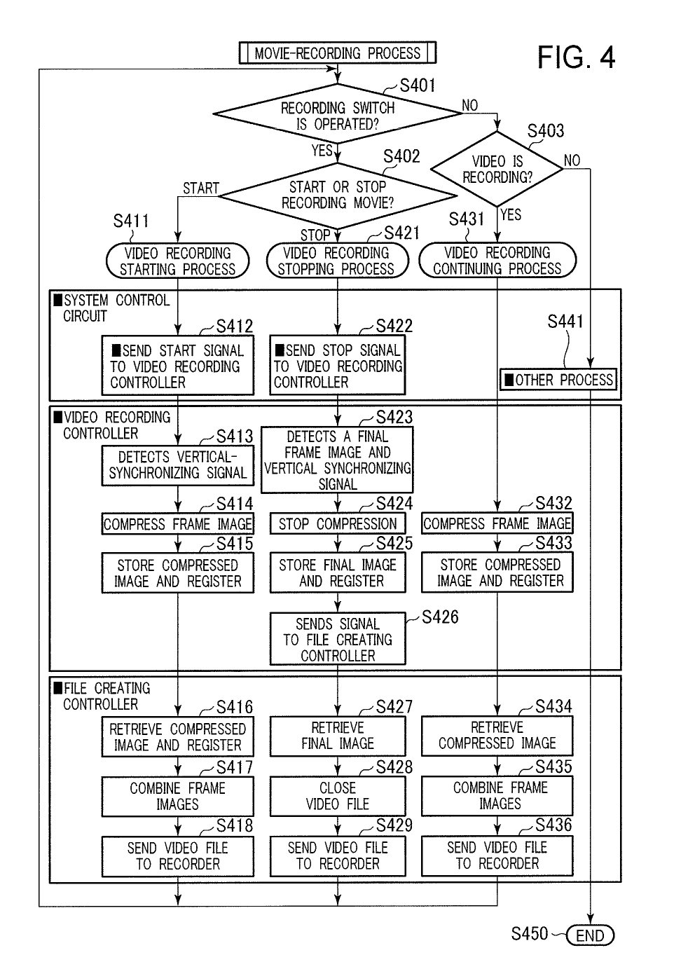

### DESCRIPTION OF THE PREFERRED EMBODIMENTS

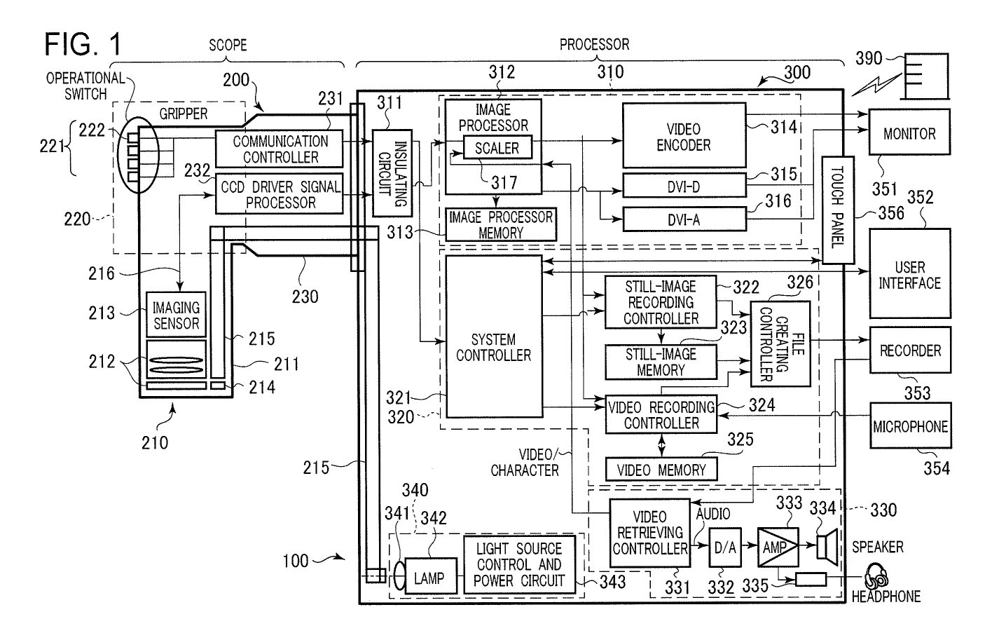

The present invention is described below with reference to the embodiments shown in the drawings. The constructions of an endoscope 100 are described hereinafter with reference to FIG. 1.

The endoscope 100 mainly comprises a scope 200, a processor 300, a server 400, a monitor 351, and a recorder 353 that is a USB memory device or hard disk, for example.

The scope 200 comprises an insertion part 210 that is inserted inside of an observational object, e.g., a human body, a gripper 220 that is held by a user, and a connector 230. The gripper 220 is connected to the processor 300 by the connector 230.

A flexible tube 210 is provided at the tip of the insertion part 210. A photographic lens 212, an imaging sensor 213, and an illumination fiber 215 are provided in the flexible tube 210.

The illumination fiber 215 emits light created by a light-source block 340, and illuminates the object through the illumination lens 214.

The photographic lens 212 projects an object image onto the imaging sensor 213. The imaging sensor 213 photographs the object image and outputs an image signal. The image signal is sent to the connector 230 through an image signal wire 216 that is provided in the flexible tube 211.

The gripper 220 comprises a plurality of operational switches 221 that are projected from a surface of the gripper 220. The operational switch 221 comprises a still-image recording switch 222. The still-image recording switch 222 is used to record a still image. Therefore, a user operates the operational switch 221 so as to control the operation of the endoscope 100. The connector 230 comprises a communication controller 231 and a processing circuit 232. The communication controller 231 receives a signal from the operational switch 221 and sends the signal to the processor 300. The processing circuit 232 comprises a CCD driver and a signal processor. The CCD driver sends a driving signal to the imaging sensor 213. The signal processor receives an image signal from the imaging sensor 213, processes the received image signal, and sends the processed image signal to the processor 300.

The processor 300 is described below. The processor 300 comprises an insulating circuit 311, an image-processing block 310, a control block 320, a retrieving block 330, and the light source block 340. The insulating circuit 311 insulates the scope and the processor 300. The image-processing block 310 processes an image that is received from the scope 200. The control block 320 controls the endoscope 100. The retrieving block 330 retrieves an image from the recorder 353. The light source block 340 creates illumination light.

The image-processing block 310 is described below. The image processing block 310 mainly comprises an image processor 312, an image processor memory 313, a display video encoder 314, a DVI-D converter 315, and a DVI-A converter 316.

While a user observes an object, the image processor 312 receives image signals continuously from the imaging sensor 213 through the insulating circuit 311, and creates frame images continuously. The image processor 312 uses the image processor memory 313 as a temporary memory and processes the received image signals continuously so that the frame images are created. During this process, the scaler 317 processes image signals to properly adjust their aspect ratios, vertical frequency and quality of frame image. The created frame is sent to the display video encoder 314, a still-image storing controller 322 and a video storing controller 324 that are described hereinafter. A user can recognize frame images that are continuously displayed on the monitor 351 as video.

While a stored video is played, the image processor 312 continuously receives image signals from the video retrieving controller 331, and creates frame images continuously using the image processor memory 313 as a temporary memory. During this process, the scaler 317 processes image signals to properly adjust their aspect ratios, vertical frequency and quality of frame image. The created frame images are sent to the display video encoder 314. The video-retrieving controller 331 and the event signal are described hereinafter.

The display video encoder 314 converts the frame images to a format that can be displayed by the monitor 351, and outputs to the monitor 351. The DVI-D converter 315 converts the format of the frame images to DVI-D format, and outputs to the monitor 351. The DVI-A converter 316 converts the format of the frame images to the DVI-A format, and outputs to the monitor 351.

The control block 320 is described below. The control block 320 comprises a system control circuit 321, a still-image recording controller 322, a still-image memory 323, a video storing controller 324, a video memory 325, and a file creating controller 326.

The system control circuit 321 is connected to a user interface 352 and a touch panel 356, which may be a keyboard, mouse, footswitch or menu button, and receives instructions from a user through the user interface 352 and the touch panel 356. Then, it controls the endoscope according to the received instructions.

The still-image recording controller 322 receives a frame image from the image processor 312, and creates a still image from the frame image using the still-image memory 323 as a temporary memory. The process of creating still images is described below. When a user depresses the still-image recording switch 222, a signal is sent from the still-image recording switch 222 to the system control circuit 321 through the communication controller 231. The system control circuit 321 that received the signal sends an instruction signal that represents the creation of a still image to the still-image recording controller 322. The still-image recording controller 322 uses a predetermined image compression method to compress a frame image that it received from the image processor 312 when the still-image recording controller 322 receives the signal, and outputs the compressed frame image as a still image. The still image is sent to the file creating controller 326. The frame image is compressed by the JPEG method, for example.

The video recording controller 324 receives a frame image from the image processor 312, and creates a video from the frame image using the video memory 325 as a temporary memory. When a user depresses the operational switch 221, a signal is sent from the still-image recording switch 222 to the system control circuit 321 through the communication controller 231. The system control circuit 321 that received the signal sends an instruction signal that represents the creation of the video to the video recording controller 324. Using a predetermined video compressing method, the video recording controller 324 compresses a frame image that is received from the image processor 312 when the video recording controller 324 receives the signal, and outputs the compressed frame image as a video. The video recording controller 324 is connected to a microphone 354. When a user speaks into the microphone 354, the microphone 354 converts the user's voice to an audio signal and sends it to the video-recording controller 324. In the case that the video-recording controller 324 is recording a video at that time, the video-recording controller 324 combines and compresses the audio signal and the frame image as a video, and sends the video to the file creating controller 326. The frame image and the audio signal are compressed by MPEG-2 or MPEG-4, for example.

The file creating controller 326 sends the received still image and the received video to the recorder 353 with proper communication protocol. The communication protocol is USB or IEEE1384, for example. The file creating controller 326 may send the received still image and the received video to the server 400 over a wireless LAN. The server 400 receives and records the still image and the video.

The retrieving block 330 is described below. The retrieving block 330 mainly comprises the video-retrieving controller 331, a D/A converter 332, an amplifier 333, a speaker 334, and a headphone jack 335.

The video retrieving controller 331 is connected to the recorder 353 and the D/A converter 332, and retrieves a video file stored in the recorder 353. Then, it decompresses the video file and produces a frame image and sound signal in succession. The frame image is sent to the image processor 312. The sound signal is sent to the D/A converter 332. The D/A converter 332 converts the sound signal to an analog sound signal and sends it to the amplifier 333. The amplifier 333 amplifies the analog sound signal to an appropriate level, and sends it to the speaker 334 and the headphone jack 335.

The light-source block 340 is described below. The light-source block 340 mainly comprises a condenser lens 341, a lamp 342, and a light-source control and power circuit 343. The light-source control and power circuit 343 is powered from a processor power circuit (not shown) included in the processor 300, and outputs that is appropriate for the lamp 342 to the lamp 342. The lamp 342 receives electric power from the light-source control and power circuit 343 and emits illumination light. The condenser lens 341 focuses the illumination light created by the lamp 342 on the illumination fiber 215, so that the illumination light is provided to the illumination fiber 15.

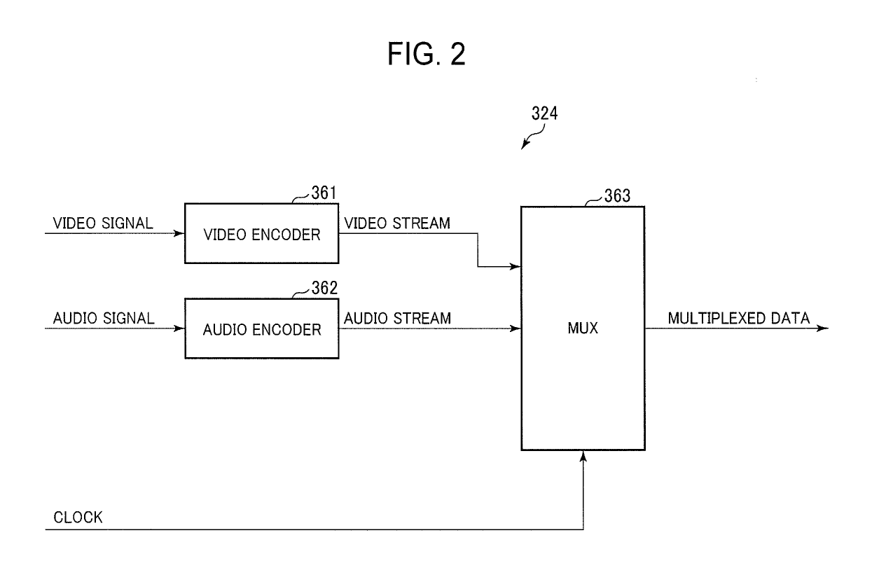

The construction of the video recording controller 324 is described below with reference to FIG. 2. video recording controller 324 mainly comprises a compression video encoder 361, an audio encoder 362, and a multiplexer 363. The audio encoder 362 receives a sound signal from the microphone 354, compresses the sound signal, and outputs an audio stream. Therefore, the audio stream is created by compressing a sound signal and then sent to the multiplexer 363. The compression video encoder 361 receives a frame image from the image processor 312, compresses the frame image to a video stream, and outputs the video stream. Therefore, the video stream is created by compressing frame images of a video and then sent to the multiplexer 363. The multiplexer 363 receives the audio stream and video stream, combines and compresses them, and outputs as video.

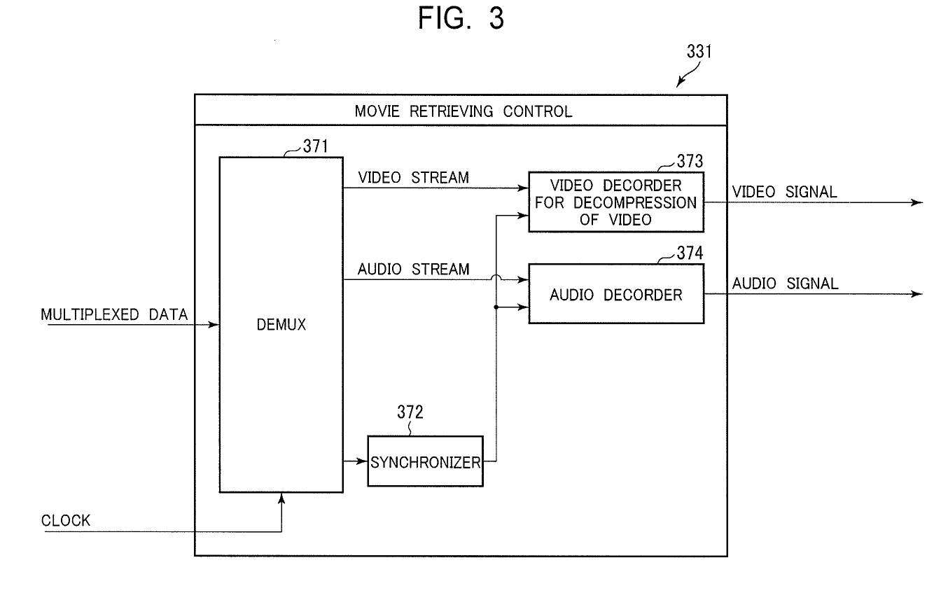

The construction of the video retrieving controller 331 is described below with reference to FIG. 3. The video-retrieving controller 331 mainly comprises a demultiplexer 371, a synchronizer 372, a video decoder 373, and an audio decoder 374.

The demultiplexer 371 receives a video file from the recorder 353 and clock signal from a clock generator (not shown). Then, it synchronizes with the clock signal and produces video stream, audio stream, event stream, and a synchronization signal from the video file. The video stream is sent to the video decoder 373. The audio stream is sent to the audio decoder 374. The synchronization signal is sent to the video decoder 373 and the audio decoder 374 through the synchronizer 372.

The video decoder 373 converts the video stream to frame images and outputs the frame images synchronously with synchronization signals. The audio decoder 374 converts the audio stream to an audio signal and outputs the audio signal synchronously with a synchronization signal. The frame images and audio signal are output synchronously with a synchronization signal, so that the frame images and audio signal are reproduced without misalignment.

The video-recording process is described below with reference to FIG. 5. The video-recording process is carried out periodically by the processor 300 while the processor 300 is in use.

In Step S401, it is determined whether the operational switch 221 is operated or not. In the case that the operational switch 221 is operated, the process proceeds to Step S402. In the case that the operational switch 221 is not operated, the process proceeds to Step S403.

In Step S402, it is determined whether the operation of the operational switch 221 corresponds to the starting or stopping of recording of a video. In the case that it corresponds to the starting of recording of a video, a video is recorded from Step S411 to Step S418. In the case that it corresponds to the stopping of recording of a video, recording of a video is stopped in Step S421 to Step S429.

In Step S403, it is determined whether a video is recording or not. In the case that a video is recording, recording of a video continues from Step S431 to S436. In the case that the video is not recording, another process is carried out and the video recording process ends at Step S450.

The video-recording starting process from Step S411 to Step S418 is described below. In Step S412, the system control circuit 321 sends a signal that indicates the start of recording to the video-recording controller 324. Steps S413 to S415 are carried out by the video-recording controller 324. In Step S413, the video-recording controller 324 detects a vertical synchronizing signal from the frame image that is received from the image processor 312. In Step S414, a frame image is compressed. In Step S415, the video memory 325 stores the compressed frame image. The next Steps S416 to S418 are carried out by the file creating controller 326. In Step S416, the file creating controller 326 retrieves the compressed frame image from the video memory 325 through the video-recording controller 324. In Step S417, a plurality of frame images is combined so that a video file is created. In Step S418, the video file is sent to and stored in the recorder 353, and the process returns to Step S401.

The video-recording stopping process from Step S421 to Step S429 is described below. In Step S422, the system control circuit 321 sends a signal to the video-recording controller 324 indicating that recording of the video is to stop. Steps S423 to S426 are carried out by the video-recording controller 324. In Step S423, the video-recording controller 324 detects a final frame image and vertical synchronizing signal from the frame image that is received from the image processor 312. In Step S424, the final frame image is compressed, and image compression ends. In Step S425, the video memory 325 stores the compressed frame image. In Step S426, the video-recording controller 324 sends a signal that indicates completion of compression of the final frame image to the file creating controller 326. The next Steps S427 to S429 are carried out by the file creating controller 326. In Step S427, the file creating controller 326 retrieves the compressed final frame image from the video memory 325 through the video-recording controller 324. In Step S428, a plurality of frame images is combined so that a video file is created, and then, the video file is closed. In Step S429, the video file is sent to and stored in the recorder 353, the process of Steps S421 to S429 ends, and the process returns to Step S401.

The video-recording continuation process from Step S431 to Step S436 are described below. Steps S432 and S433 are carried out by the video-recording controller 324. In Step S432, the received frame image is compressed. In the next Step S433, the video memory 325 stores the compressed frame image. The next Steps S434 to S436 are carried out by the file creating controller 326. In Step S434, the file creating controller 326 retrieves the compressed frame image from the video memory 325 through the video-recording controller 324. In Step S435, a plurality of frame images is combined so that a video file is created. In Step S436, the video file is sent to and stored in the recorder 353, the process of Steps S431 to S436 ends, and the process returns to Step S401.

According to the embodiment, a video file is stored in the recorder at the same time the monitor 351 displays the video.

A video is compressed, so that the entire observation process is recorded even in the case that the observation takes a long time. Therefore, a user will not lose any part of an observation.

A still image can be created from a recorded video, so that a user need not operate the still-image recording switch 222 during observation or a surgical procedure.

Sound and video are simultaneously recorded, so that all of the data produced during a surgical procedure is recorded.

A patient can watch a recorded video after a surgical procedure, so that the patient can understand precisely what occurred during the surgical procedure. A third party can study a surgical procedure with a recorded video.

Note that the imaging sensor is not limited to a CCD, and may be a solid-state image sensing device, e.g., a CMOS.

The methods of compressing still images and video are not limited to those above.

In the video recording process, a video file may not be sent to the recorder 353 and may be sent to the server 400 instead. The file creating controller 326 may send a still image and a video to the server 400 through a wired LAN.

Although the embodiment of the present invention has been described herein with reference to the accompanying drawings, obviously many modifications and changes may be made by those skilled in this art without departing from the scope of the invention.

The present disclosure relates to subject matter contained in Japanese Patent Application No. 2012-178775 (filed on Aug. 10, 2012), which is expressly incorporated herein, by reference, in its entirety.

1. An endoscope comprising:
a video compiler that continuously receives image signals and creates a video file with the image signals;
a still-image compiler that receives the image signals, and creates a still image;
a monitor that receives the video file from the video compiler and continuously displays the video;
a recorder that receives the video file from the video compiler and receives the still image from the still-image compiler, and stores the video file and the still image.

2. The endoscope according to claim 1, further comprising a sound picker that outputs sound signal, wherein the video compiler receives the sound signal from the sound picker and combines the sound signal with the video.

3. The endoscope according to claim 1, wherein the still-image compiler compresses the image signal and creates a still-image file.

4. The endoscope according to claim 1, wherein the video compiler compresses the image signal and creates a video file.

5. The endoscope according to claim 1 further comprising a sender that receives the video file from the video compiler, and receives the still image from the still-image compiler, and sends the video file and the still image to the recorder through a network.

6. The endoscope according to claim 1, wherein the still-image compiler creates a still image from the video file stored in the recorder.

7. The endoscope according to claim 1 further comprising a still-image recording switch that is operated by a user, wherein the still-image compiler creates a still image in the case that the still-image recording switch is operated.

8. The endoscope according to claim 1, wherein the monitor displays a plurality of video files and a plurality of still images at the same time.

9. The endoscope according to claim 2, wherein the video compiler compresses the sound signal so that creates a sound file.
